(19) United States
(12) Patent Application Publication
(10) Pub. No.: US 2026/0290119 A1
(43) Pub. Date: Sep. 24, 2026

(54) MODELS TURNING TEXT, VISUAL, AND OTHER INPUT INTO ACTIONS WITHIN CASINO GAMES

(71) Applicant: IGT, Las Vegas, NV (US)

(72) Inventors: Gaurav Jariwala, Halifax (CA); Stefan Keilwert, St. Josef (AT); Michael Russ, Graz (AT); Soheil Latifi, Brampton (CA); Sven Aurich, Schwanberg (AT)

(21) Appl. No.: 19/083,861

(22) Filed: Mar. 19, 2025

(51) Int. Cl. G07F 17/32

(52) U.S. Cl. CPC G07F 17/3227; G07F 17/3237

(57) ABSTRACT

Embodiments of the present disclosure are directed to using trained models to customize actions electronic casino games based on text visual and other input. According to one embodiment, generative models can be trained specifically for casino games and used to empower players to shape their gaming experiences through text or visual prompts. Players can provide instructions to tailor their gameplay. The generative model can interpret player prompts with precision, allowing users to dictate their preferred betting strategies and/or game actions. Such customizations can include, but are not limited to, adjusting wager amounts based on credit meter values, execute specific actions in response to visual cues, and/or others. Moreover, players can input videos of actions they want replicated in the game.

### BACKGROUND

The present disclosure is generally directed to electronic casino games and more particularly to customizing actions electronic casino games based on text visual and other input.

As a player, it can be challenging to find personalized gaming experiences that cater to individual preferences and strategies. Traditional casino games often lack adaptability, leading to repetitive gameplay and reduced enjoyment. Players desire a more interactive and dynamic gaming environment where they can provide prompts and see their decisions reflected in the gameplay.

### BRIEF SUMMARY

Embodiments of the present disclosure are directed to using trained models to customize actions electronic casino games based on text visual and other input. According to one embodiment, a method for customizing an electronic casino game can comprise maintaining a plurality of trained models related to the electronic casino game. The plurality of trained models can comprise a first model representing actions in the electronic casino game.

A prompt defining player changes to the actions in the electronic casino game can be received. The prompt can comprise text describing the player changes to the electronic casino game. Gameplay data can be generated using a generative Artificial Intelligence (AI), the first model, and the received prompt. The generated gameplay data defines changes to the electronic casino game. For example, the gameplay data can define a betting strategy for a player in the electronic casino game.

In some cases, the plurality of trained models can comprise a second model representing visual elements of the electronic casino game. In such cases, the prompt can comprise visual data illustrating the player changes to the electronic casino game. For example, the visual data can comprise a video. The prompt can further define player changes to the visual elements of the electronic casino game. For example, the video can illustrate one or more actions and the player changes can comprise replicating the one or more actions illustrated by the video in the electronic casino game. The generated gameplay data can be provided to a gaming system executing the electronic casino game.

According to another embodiment, a system can comprise a processor and a memory coupled with and readable by the processor. The memory can store therein a set of instructions which, when executed by the processor, causes the processor to maintain a plurality of trained models related to the electronic casino game, wherein the plurality of trained models represent actions and visual elements in the electronic casino game. In some cases, the plurality of models can additionally, or alternatively, comprise a tuned model pertaining to video visual elements of the electronic casino game based on a transformer for casino games. Additionally, or alternatively, the plurality of models can comprise a Conditional Variational Autoencoder trained on sample casino game visual element embedding for given prompts.

The instructions can further cause the processor to receive a first prompt defining player changes to the actions in the electronic casino game, generate gameplay data using a generative Artificial Intelligence (AI), the plurality of models, and the received first prompt, wherein the generated gameplay data defines changes to the actions and the visual elements of the electronic casino game, and provide the generated gameplay data to a gaming system executing the electronic casino game.

In some cases, the instructions further cause the processor to receive a second prompt defining a player request for information related to dynamics of the electronic casino game, generate explanatory information related to the dynamics of the electronic casino game using the generative AI, the plurality of models, and the received second prompt, and provide the generated explanatory information related to the dynamics of the electronic casino game to a player of the electronic casino game.

Additionally, or alternatively, the instructions can cause the processor to receive player feedback regarding changes to the actions and the visual elements of the electronic casino game based on the provided gameplay data and train the plurality of models based on the received player feedback.

The instructions can additionally, or alternatively, cause the processor to maintain a log of player behavior related to the electronic casino game for a player account, receive a request for the log of player behavior related to the electronic casino game for the player account, and provide the log of player behavior related to the electronic casino game to a player associated with the player account.

Additionally, or alternatively, the instructions can cause the processor to record the received first prompt and in response to a request to generate a second prompt, provide the recorded first prompt; and in response to a selection of the first prompt, use the first prompt as the second prompt.

According to another embodiment, a system can comprise a communications network and a first gaming system coupled with the communications network. The first gaming system can comprise a processor and a memory coupled with and readable by the processor of the first gaming system and storing therein a set of instructions which, when executed by the processor of the first gaming system, causes the processor of the first gaming system to execute an electronic casino game.

The system can further comprise a game customization system coupled with the communications network. The game customization system can comprise a processor and a memory coupled with and readable by the processor of the game customization system and storing therein a set of instructions which, when executed by the processor of the game customization system, cause the processor of the game customization system to maintain a plurality of trained models related to the electronic casino game, wherein the plurality of trained models represent actions and visual elements in the electronic casino game, receive a first prompt defining player changes to the actions in the electronic casino game defined by a first player of the electronic casino game, generate gameplay data using a generative Artificial Intelligence (AI), the plurality of models, and the received first prompt, wherein the generated gameplay data defines changes to the actions and the visual elements of the electronic casino game, and provide the generated gameplay data to the first gaming system

The instructions stored in the memory of the first gaming system can further cause the processor of the first gaming system to apply the gameplay data to the electronic casino game. For example, the gameplay data can define a betting strategy in the electronic casino game for the first player. In such cases, the instructions stored in the memory of the first gaming system can further cause the processor of the first gaming system to execute the electronic casino game automatically according to the betting strategy for the first player.

The system can further comprise a second gaming system coupled with the communications network. The second gaming system can comprise a processor and a memory coupled with and readable by the processor of the second gaming system and storing therein a set of instructions which, when executed by the processor of the second gaming system, causes the processor of the second gaming system to execute the electronic casino game and the instructions stored in the memory of the game customization system cause the processor of the game customization system to provide the generated gameplay data to the first gaming system. In such cases, the instructions stored in the memory of the second gaming system can cause the processor of the second gaming system to apply the gameplay data to the electronic casino game when the electronic casino game is played on the second gaming system by the first player. In some cases, the memory of the second gaming system cause the processor of the second gaming system to apply the gameplay data to the electronic casino game when the electronic casino game is played on the second gaming system by a second player.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure may be implemented.

FIG. 2 is a block diagram illustrating additional details of components of an exemplary game customization system according to one embodiment of the present disclosure.

FIG. 3 is a block diagram illustrating additional details of components of an exemplary gaming system according to one embodiment of the present disclosure.

FIG. 4 is a flowchart illustrating an exemplary process for game customization according to one embodiment of the present disclosure.

FIG. 5 is a flowchart illustrating an exemplary process for game customization according to another embodiment of the present disclosure.

FIG. 6 is a flowchart illustrating an exemplary process for game customization according to another embodiment of the present disclosure.

FIG. 7 is a flowchart illustrating an exemplary process for game customization according to another embodiment of the present disclosure.

FIG. 8 is a flowchart illustrating an exemplary process for game customization according to another embodiment of the present disclosure.

### DETAILED DESCRIPTION

Embodiments of the present disclosure are directed to using trained models to customize actions electronic casino games based on text visual and other input. According to one embodiment, generative models can be trained specifically for casino games and used to empower players to shape their gaming experiences through text or visual prompts. Players can provide instructions to tailor their gameplay. The generative model can interpret player prompts with precision, allowing users to dictate their preferred betting strategies and/or game actions. Such customizations can include, but are not limited to, adjusting wager amounts based on credit meter values, execute specific actions in response to visual cues, and/or others. Moreover, players can input videos of actions they want replicated in the game.

By offering a highly customizable and interactive gaming experience driven by Artificial Intelligence (AI) technology, the game provider can differentiate itself from competitors and attract a broader audience of players seeking personalized gameplay. The game provider can monetize this model through various methods. They could implement subscription mode, offering players access to advanced features for a recurring fee. Licensing this model to other gaming platforms or casino operators for a fee in another potential revenue stream. Data collected through this model could be aggregated and anonymized, then monetized through data licensing agreements.

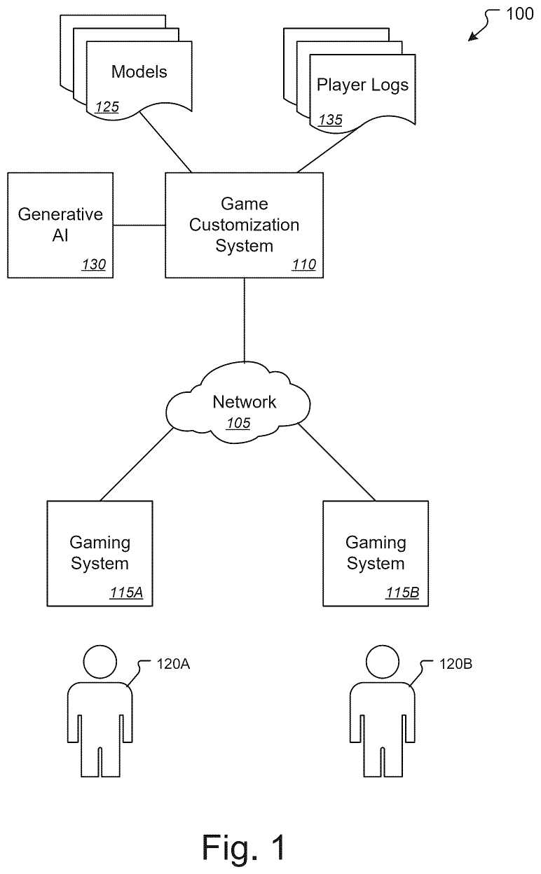

FIG. 1 is a block diagram illustrating an exemplary environment in which embodiments of the present disclosure may be implemented. As illustrated in this example, the environment 100 can comprise a game customization system 110 coupled with a communications network 105. Generally speaking, the game customization system 110 can comprise any one or more servers and/or other computing devices as known in the art. The communications network 105 can comprise any one or more wired and/or wireless, local-area and/or wide-area networks as known in the art including, but not limited to, the Internet. Also coupled with the communications network 105 can be any number of gaming systems 115A-115B. Generally speaking, each gaming system 115 can comprise, for example, any Electronic Gaming Machine (EGM), kiosk, or similar gaming system as may be found in a casino or other gaming venue. The gaming system 115 can each execute any of a variety of electronic games including, but not limited to slots, video slots, video poker, keno, etc. to be played by any number of players 120A-120B.

Generally speaking, the game customization system 110 can customize an electronic game being executed on a gaming system 115A based on one or more prompts from a player 120A of the electronic game. As will be described, the prompt(s) can be textual, visual, or other content. The prompt(s) can be directed to changing actions and/or visuals within the game. For example, a text prompt from the player 120A, e.g., entered through the gaming system 115A or other device, can describe an action to be taken upon the occurrence of some event or condition within the game. In another example, a visual prompt can provide an indication of a graphical or other visual element to be used within the game. In some cases, the visual prompt can comprise a video clip.

More specifically, customizing an electronic casino game by the game customization system 110 can comprise maintaining a plurality of trained models 125 related to the electronic casino game. The plurality of trained models 125 can comprise a first model representing actions in the electronic casino game.

A prompt defining player changes to the actions in the electronic casino game can be received, e.g., from the gaming system 115A, a mobile device (not shown here) of the player 120A, or another device. The prompt can comprise text describing the player changes to the electronic casino game. Gameplay data can be generated using a generative Artificial Intelligence (AI) 130, the first model, and the received prompt. The generated gameplay data can define changes to the electronic casino game. For example, the gameplay data can define a betting strategy for the player 120A in the electronic casino game.

In some cases, the plurality of trained models 125 can comprise a second model representing visual elements of the electronic casino game. In such cases, the prompt can comprise visual data illustrating the player changes to the electronic casino game. For example, the visual data can comprise a video. The prompt can further define player changes to the visual elements of the electronic casino game. For example, the video can illustrate one or more actions and the player changes can comprise replicating the one or more actions illustrated by the video in the electronic casino game. In such cases, the generated gameplay data can further include generated actions based on the second prompt. The generated gameplay data can be provided to a gaming system 120A executing the electronic casino game to be implemented therein.

Stated another way, the input data for the game customization system 110 can be one or more text prompts stating the actions needed to be taken and/or can be a visual input like a video of actions. This input can be collected from the player 120A while there can also be other input like the state of game, e.g., the credit meter value, symbols on the reels of the game, etc. Models 125 used can include a tuned video pretraining model based on a transformer for casino games to achieve a goal and a trained Conditional Variation Autoencoder to sample casino games visual embedding given a text prompt. The combination of these two models enables agents used by the game customization system 110 to follow text and visual instructions. The output gameplay data can be the actions or moves taken on the game. For example, the output gameplay data can define wager, cash out, certain strategies executed in puzzle-like bonuses, certain wagering strategies, changing games on multigame machines based on certain preconditions, e.g., hunt a jackpot based on another bank player's progress made with feeding the jackpot of the same bank of machines.

According to one embodiment, a player can save multiple gameplay data consisting of different strategies. Then the player can use a particular gameplay data with a specific strategy as input to a new game. This can be used to synthesize data with similar kind of playing behavior.

Additionally, or alternatively, a text input can be used to change game theme, reward structure, characters, etc. In some cases, prompts can be generated using predefined, selectable text blocks, through which a prompt is generated based on a combination of the predefined text blocks selected by the player. In some cases, text blocks can be proposed based on previously selected blocks similar to writing a text message when the next word is predicted by a recommender. This can give a more personalized experience and control to the players. In some cases, a player can record his commands or prompts to use them as text blocks, shortcuts, macros, etc. For example, the player can store his last X number of prompts or commands. In some cases, the player can prompt to get game details and a summary of how the applied prompts performed after playing game.

According to one embodiment, a player can train their own model(s) to perform intelligent autoplay. For example, such a model can be trained by observing a player's play behavior. In some cases, the player can “label” a play behavior, give a name or select from pre-sets. Such behaviors can be tied to an avatar and the player can give control to the avatar to play on player's behalf based on the associated model. According to one embodiment, the player can provide the model certain text or logic inputs, that make it more comprehensible to the model why the player performed which action. The result can be a model pre-trained by observing the player, but in addition, being repeatedly fine-tuned or hyper-trained based on the player explaining why they performed their action. The more a player is keen on fine-tuning their model, the faster it will become more accurate.

Depending on the labelled behavior, such a model can continue autonomously playing on the player's behalf. This may depend on the complexity of the strategy executed by the player. For simple rules like “Cash out after doubling up my initial cash in,” then the model can use a single input, i.e., actual credit meter vs. initial cash in amount. Other similar scenarios might be “Cash out after hitting the bonus,” “cash out after a high win,” e.g., X times greater than bet, etc. For more complex strategies, though, the model can use a series of instructions, learning over time, and having a memory of previous game events. For example, the memory for a current gaming session can be set to last for the whole gaming session, so that the model is aware of everything that happened in the session. Such more complex strategies might be: Play certain games with Max. bet after winning big, cashing out after a losing streak of 15 or more spins, after winning a bonus play down to the next “even” credit meter amount, e.g., $50, etc. As mentioned above, such strategies, both simpler strategies and/or more complex strategies, can be facilitated by the model both observing a player's gameplay, but also by the player feeding the model with concrete strategy information.

According to one embodiment, the player can give the model feedback on its actions. In order to give the model feedback, the player can actively watch the model play during its “early life cycle” and intersect as needed. In another implementation, the model's play session can be recorded and, e.g., upon request, can be sent over to the player's mobile device or other device, e.g., via a web link, where the player can, retrospectively, watch the model's gameplay and, retrospectively, give feedback to the model from which it will learn for future sessions. For example, the player can indicate dos and don'ts while watching the replay and the model can be trained and improved based thereon. In situations where the model does not clearly know how to behave or what to do, it could pause the game and request the player to perform an action on the model's behalf. The model can then be trained on that behavior. In some cases, a player may train multiple different models and execute one or another whenever wanted.

According to one embodiment, such automated play using personalized models can be used to play in a pre-defined action tournament. In such cases, the player can provide pre-defined actions in the form of chained action prompts or a gameplay video before the start of the tournament. There can be certain rules set for these tournaments like how many actions players can specify, how many cash ins are allowed, and a limit can even be set to cash in amount.

According to one embodiment, remote actions can be provided. In such cases, the game customization system 110 can provide a lightweight text app like ChatGPT through which the player can prompt the action which can then processed on the game customization system 110 which can return a text message to the player indicating whether the player won or not.

According to one embodiment, model sharing and cross-interactions can be provided. For example, players can share their trained models with other players thereby collecting more experience and practice. Additionally, or alternatively, players can use their models to compete against one another, e.g., like in an above-mentioned tournament setting. In some cases, players can merge multiple different players'models into one new model.

According to one embodiment, the game customization system 110 can provide a reverse process for a player's playing log. For example, players can request a playing summary, based on their player record. In response, the player can be provided with a written description of their playing behavior by the game customization system 110.

According to one embodiment, the game customization system 110 can support multigame playing. For example, a player can play with multiple machines, issuing commands such as, place minimum wager on both machines.

According to one embodiment, the game customization system 110 can support multi-language models. For example, commands or prompts can be issued in any language, making it easy for everyone to use the machine.

According to one embodiment, the game customization system 110 can provide player support via a gaming system. For example, to create some commands, the player can be provided with feedback about some setting limits like MaxBet, MinBet, NumberOfLines by the game customization system 110.

According to one embodiment, the game customization system 110 can support a game demo-mode without credit. That is, the game customization system 110, through the gaming system, can present features to the user in a kind of demo mode without money just for testing the use of models for customizing a game.

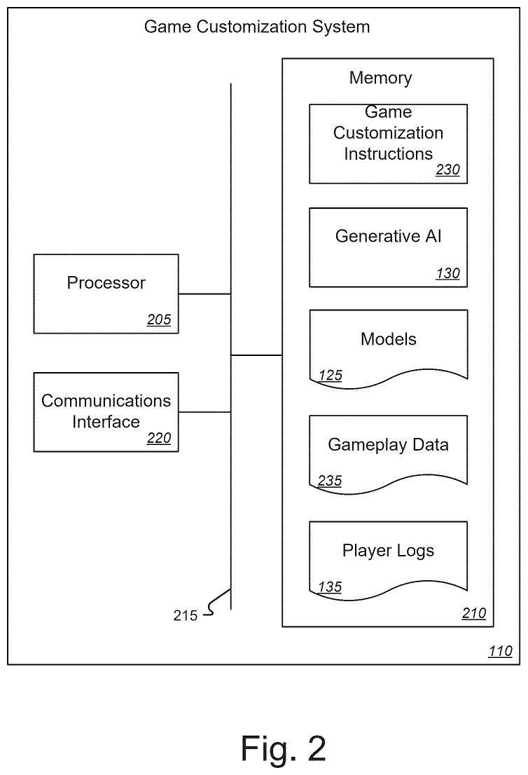

FIG. 2 is a block diagram illustrating additional details of components of an exemplary game customization system according to one embodiment of the present disclosure. As illustrated in this example, a game customization system 110 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the game customization system 110 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215. The communication interface(s) 220 can comprise, for example, an Ethernet, Bluetooth, WiFi, cellular, and/or other type of wired and/or wireless communications interface. Via the communication interface(s) 220, the game customization system 110 can communicate with other devices and/or systems through a communications network 110 as described above.

The memory 210 can store therein a set of game customization instructions 230 which, when executed by the processor 205, cause the processor 205 to maintain a plurality of trained models 125 related to the electronic casino game. The plurality of trained models 125 can comprise a first model representing actions in the electronic casino game.

The game customization instructions 230 can further cause the processor to receive a prompt defining player changes to the actions in the electronic casino game. The prompt can comprise text describing the player changes to the electronic casino game. The game customization instructions 230 can further cause the processor to generate gameplay data 235 using a generative AI 130, the first model, and the received prompt. The generated gameplay data defines changes to the electronic casino game. For example, the gameplay data can define a betting strategy for a player in the electronic casino game.

In some cases, the plurality of trained models 125 can comprise a second model representing visual elements of the electronic casino game. In such cases, the prompt can comprise visual data illustrating the player changes to the electronic casino game. For example, the visual data can comprise a video. The prompt can further define player changes to the visual elements of the electronic casino game. For example, the video can illustrate one or more actions and the player changes can comprise replicating the one or more actions illustrated by the video in the electronic casino game. In such cases, the generated 415 gameplay data 340 can further include generated actions based on the second prompt. The game customization instructions 230 can further cause the processor to provide the generated gameplay data 340 to a gaming system 115A executing the electronic casino game to be implemented therein.

In some cases, the game customization instructions 230 can further cause the processor to receive a second prompt. The second prompt can define a player request for information related to dynamics of the electronic casino game. In response, the game customization instructions 230 can further cause the processor to generate explanatory information related to the dynamics of the electronic casino game using the generative AI 130, the plurality of models 125, and the received second prompt and provide generated explanatory information related to the dynamics of the electronic casino game to a player of the electronic casino game, e.g., through the gaming system 115A, the player's mobile device, etc.

Additionally, or alternatively, the game customization instructions 230 can further cause the processor to receive player feedback regarding changes to the actions and the visual elements of the electronic casino game based on the provided gameplay data 340, e.g., through the gaming system 115A, the player's mobile device, or another system or device. In such cases, The game customization instructions 230 can further cause the processor to train one or more models of the plurality of models 125 based on the received player feedback.

The game customization instructions 230 can additionally, or alternatively, cause the processor to maintain a log of player behavior 135 related to the electronic casino game for a player account, e.g., based on information received from the gaming system 115A executing the electronic game. The game customization instructions 230 can further cause the processor to receive a request for the log of player behavior 135 related to the electronic casino game for the player account, e.g., from the gaming system 115A, the player's mobile device, or another system and provide the log of player behavior 135 related to the electronic casino game to a player associated with the player account in response to the request, e.g., through the requesting system or device or another system or device associated with the player.

Additionally, or alternatively, the game customization instructions 230 can further cause the processor to save the received first prompt. At some later point in time, the game customization instructions 230 can further cause the processor to receive a request to generate a second prompt, e.g., from a gaming system 115A, mobile device of the player, or another system or device. In response to the request to generate the second prompt, the game customization instructions 230 can further cause the processor to retrieve the recorded first prompt and provide the first prompt to the requesting system. The game customization instructions 230 can further cause the processor to receive an indication of a selection of the first prompt thereby indicating the first prompt should be repeated. In response to a selection of the first prompt, The game customization instructions 230 can further cause the processor to use the first prompt as the second prompt.

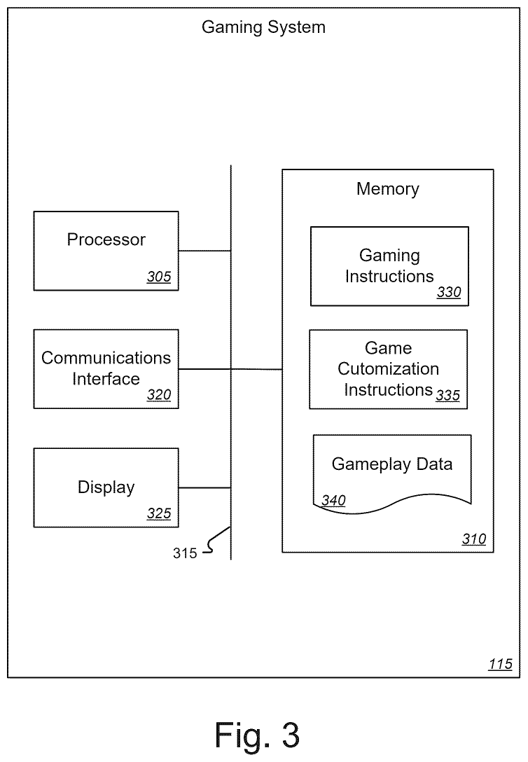

FIG. 3 is a block diagram illustrating additional details of components of an exemplary gaming system according to one embodiment of the present disclosure. As illustrated in this example, a gaming system 115 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320, and a display 325. The communication interfaces 320 can comprise, for example, an Ethernet, Bluetooth, WiFi, cellular, and/or other type of wired and/or wireless communications interface. The display 325 can comprise a Liquid Crystal Display (LCD), Light Emitting Diode (LED), Organic Light Emitting Diode (OLED), or other type of display.

The memory 310 can store therein a set of gaming instructions 330 which, when executed by the processor 305, causes the processor 305 to execute an electronic game. The memory 310 can also store therein a set of game customization instructions 335 which, when executed by the processor 305, causes the processor 305 to receive, through the communications interface 320, gameplay data 340 from the game customization system 110 and apply the gameplay data 340 to the electronic game, e.g., to change actions and/or visual elements in the executing game. These changes can be applied while the player is playing the game. Additionally, or alternatively, applying the changes can comprise automatically executing the electronic game by the gaming instructions 330 and game customization instructions 335 according to the gameplay data 340. In some cases, the game customization instructions 335 can further cause the processor 305 other functions including, but not limited to, receiving and/or presenting textual, visual, and/or other prompts, e.g., through the display 325 and or other input/output devices of the gaming system 115, receiving, through the communication interface 320, from the game customization system 110, presenting explanatory information related to the electronic game and presenting the explanatory information through the display, receiving player feedback on the customized electronic game and providing that feedback to the game customization system 110 through the communication interface 320, collecting information related to player behavior during the game and providing that information to the game customization system 110 through the communication interface 320 for monitoring purposes, and/or others.

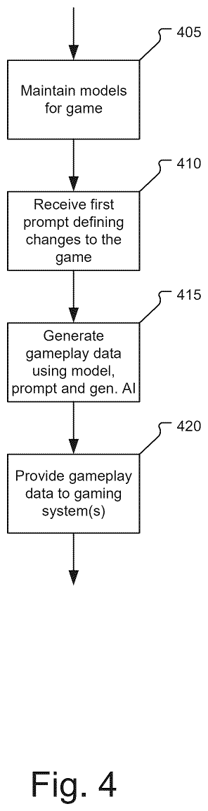

FIG. 4 is a flowchart illustrating an exemplary process for game customization according to one embodiment of the present disclosure. As illustrated in this example, customizing an electronic casino game can comprise maintaining 405 a plurality of trained models 125 related to the electronic casino game. The plurality of trained models 125 can comprise a first model representing actions in the electronic casino game.

A prompt defining player changes to the actions in the electronic casino game can be received 410. The prompt can comprise text describing the player changes to the electronic casino game. Gameplay data 235 can be generated 415 using a generative AI 130, the first model, and the received prompt. The generated 415 gameplay data can define changes to the electronic casino game. For example, the gameplay data can define a betting strategy for a player in the electronic casino game.

In some cases, the plurality of trained models 125 can comprise a second model representing visual elements of the electronic casino game. In such cases, the prompt can comprise visual data illustrating the player changes to the electronic casino game. For example, the visual data can comprise a video. The prompt can further define player changes to the visual elements of the electronic casino game. For example, the video can illustrate one or more actions and the player changes can comprise replicating the one or more actions illustrated by the video in the electronic casino game. In such cases, the generated 415 gameplay data 340 can further include generated actions based on the second prompt. The generated 415 gameplay data 340 can be provided 420 to a gaming system 115A executing the electronic casino game to be implemented therein.

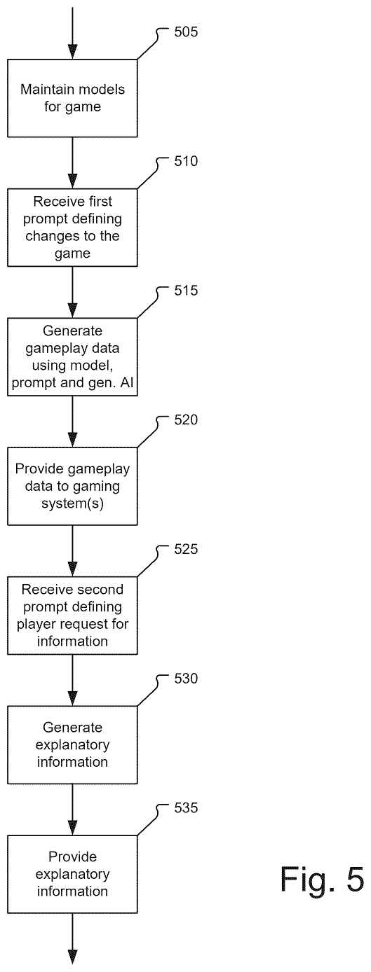

FIG. 5 is a flowchart illustrating an exemplary process for game customization according to another embodiment of the present disclosure. As illustrated in this example, customizing an electronic casino game can comprise maintaining 505 a plurality of trained models 125 related to the electronic casino game. The plurality of trained models 125 can comprise a first model representing actions in the electronic casino game.

A prompt defining player changes to the actions in the electronic casino game can be received 510. The prompt can comprise text describing the player changes to the electronic casino game. Gameplay data 340 can be generated 515 using a generative AI 130, the first model, and the received prompt. The generated 515 gameplay data can define changes to the electronic casino game. For example, the gameplay data 340 can define a betting strategy for a player in the electronic casino game.

In some cases, the plurality of trained models 125 can comprise a second model representing visual elements of the electronic casino game. In such cases, the prompt can comprise visual data illustrating the player changes to the electronic casino game. For example, the visual data can comprise a video. The prompt can further define player changes to the visual elements of the electronic casino game. For example, the video can illustrate one or more actions and the player changes can comprise replicating the one or more actions illustrated by the video in the electronic casino game. In such cases, the generated 515 gameplay data 340 can further include generated actions based on the second prompt. The generated 515 gameplay data 340 can be provided 520 to a gaming system 115A executing the electronic casino game to be implemented therein.

A second prompt can be received 525. The second prompt can define a player request for information related to dynamics of the electronic casino game. In response, explanatory information related to the dynamics of the electronic casino game can be generated 530 using the generative AI 130, the plurality of models 125, and the received second prompt. The generated explanatory information related to the dynamics of the electronic casino game can be provided 535 to a player of the electronic casino game, e.g., through the gaming system 115A, the player's mobile device, etc.

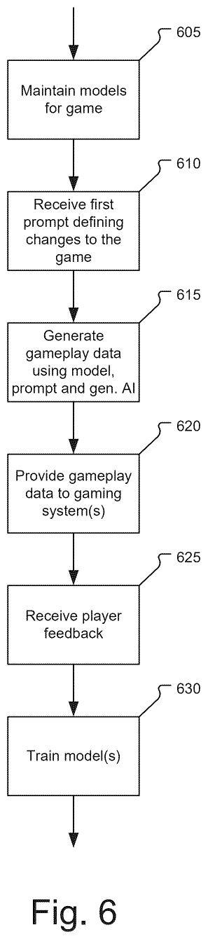

FIG. 6 is a flowchart illustrating an exemplary process for game customization according to another embodiment of the present disclosure. As illustrated in this example, customizing an electronic casino game can comprise maintaining 605 a plurality of trained models 125 related to the electronic casino game. The plurality of trained models 125 can comprise a first model representing actions in the electronic casino game.

A prompt defining player changes to the actions in the electronic casino game can be received 610. The prompt can comprise text describing the player changes to the electronic casino game. Gameplay data 340 can be generated 615 using a generative AI 130, the first model, and the received prompt. The generated 615 gameplay data 340 defines changes to the electronic casino game. For example, the gameplay data 340 can define a betting strategy for a player in the electronic casino game.

In some cases, the plurality of trained models 125 can comprise a second model representing visual elements of the electronic casino game. In such cases, the prompt can comprise visual data illustrating the player changes to the electronic casino game. For example, the visual data can comprise a video. The prompt can further define player changes to the visual elements of the electronic casino game. For example, the video can illustrate one or more actions and the player changes can comprise replicating the one or more actions illustrated by the video in the electronic casino game. In such cases, the generated 615 gameplay data 340 can further include generated actions based on the second prompt. The generated 615 gameplay data 340 can be provided 620 to a gaming system 115A executing the electronic casino game to be implemented therein.

Player feedback regarding changes to the actions and the visual elements of the electronic casino game based on the provided gameplay data 340 can be received 625, e.g., through the gaming system 115A, the player's mobile device, or another system or device. One or more models of the plurality of models 125 can then be trained 630 based on the received player feedback.

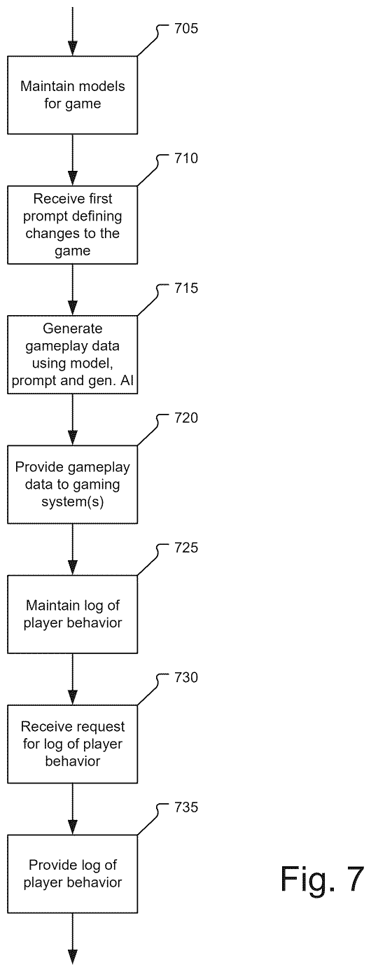

FIG. 7 is a flowchart illustrating an exemplary process for game customization according to another embodiment of the present disclosure. As illustrated in this example, customizing an electronic casino game can comprise maintaining 705 a plurality of trained models 125 related to the electronic casino game. The plurality of trained models 125 can comprise a first model representing actions in the electronic casino game.

A prompt defining player changes to the actions in the electronic casino game can be received 710. The prompt can comprise text describing the player changes to the electronic casino game. Gameplay data 340 can be generated 715 using a generative AI 130, the first model, and the received prompt. The generated 715 gameplay data 340 defines changes to the electronic casino game. For example, the gameplay data 340 can define a betting strategy for a player in the electronic casino game.

In some cases, the plurality of trained models 125 can comprise a second model representing visual elements of the electronic casino game. In such cases, the prompt can comprise visual data illustrating the player changes to the electronic casino game. For example, the visual data can comprise a video. The prompt can further define player changes to the visual elements of the electronic casino game. For example, the video can illustrate one or more actions and the player changes can comprise replicating the one or more actions illustrated by the video in the electronic casino game. In such cases, the generated 715 gameplay data 340 can further include generated actions based on the second prompt. The generated 715 gameplay data 340 can be provided 720 to a gaming system 115A executing the electronic casino game to be implemented therein.

A log of player behavior 135 related to the electronic casino game can be maintained 725 for a player account, e.g., based on information received from the gaming system 115A executing the electronic game. A request for the log of player behavior 135 related to the electronic casino game for the player account can be received 730, e.g., from the gaming system 115A, the player's mobile device, or another system. The log of player behavior 135 related to the electronic casino game can be provided 735 to a player associated with the player account in response to the request, e.g., through the requesting system or device or another system or device associated with the player.

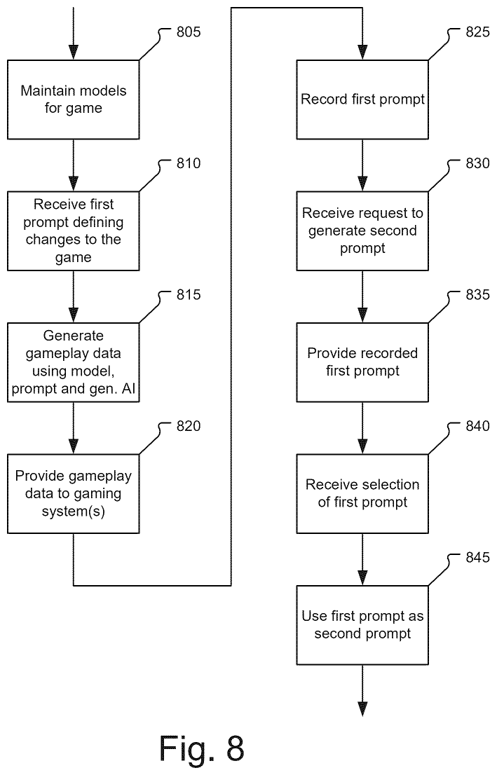

FIG. 8 is a flowchart illustrating an exemplary process for game customization according to another embodiment of the present disclosure. As illustrated in this example, customizing an electronic casino game can comprise maintaining 805 a plurality of trained models 125 related to the electronic casino game. The plurality of trained models 125 can comprise a first model representing actions in the electronic casino game.

A prompt defining player changes to the actions in the electronic casino game can be received 810. The prompt can comprise text describing the player changes to the electronic casino game. Gameplay data 340 can be generated 815 using a generative AI 130, the first model, and the received prompt. The generated 815 gameplay data 340 defines changes to the electronic casino game. For example, the gameplay data 340 can define a betting strategy for a player in the electronic casino game.

In some cases, the plurality of trained models 125 can comprise a second model representing visual elements of the electronic casino game. In such cases, the prompt can comprise visual data illustrating the player changes to the electronic casino game. For example, the visual data can comprise a video. The prompt can further define player changes to the visual elements of the electronic casino game. For example, the video can illustrate one or more actions and the player changes can comprise replicating the one or more actions illustrated by the video in the electronic casino game. In such cases, the generated 815 gameplay data 340 can further include generated actions based on the second prompt. The generated 815 gameplay data can be provided 820 to a gaming system 115A executing the electronic casino game to be implemented therein.

The received first prompt can be recorded 825 or saved. At some later point in time, a request to generate a second prompt can be received 830, e.g., from a gaming system 115A, mobile device of the player, or another system or device. In response to the request to generate the second prompt, the recorded first prompt can be retrieved and provided 835 to the requesting system. An indication of a selection of the first prompt can be received 840 thereby indicating the first prompt should be repeated. In response to a selection of the first prompt, the first prompt can be used 845 as the second prompt.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for customizing an electronic casino game, the method comprising:
maintaining, by a game customization system, a plurality of trained models related to the electronic casino game, wherein the plurality of trained models comprises a first model representing actions in the electronic casino game;
receiving, by the game customization system, a prompt defining player changes to the actions in the electronic casino game;
generating, by the game customization system, gameplay data using a generative Artificial Intelligence (AI), the first model, and the received prompt, wherein the generated gameplay data defines changes to the electronic casino game; and
providing, by the game customization system, the generated gameplay data to a gaming system executing the electronic casino game.

2. The method of claim 1, wherein the plurality of trained models comprises a second model representing visual elements of the electronic casino game, and wherein the prompt further defines player changes to the visual elements of the electronic casino game.

3. The method of claim 1, wherein the prompt comprises text describing the player changes to the electronic casino game.

4. The method of claim 1, wherein the prompt comprises visual data illustrating the player changes to the electronic casino game.

5. The method of claim 4, wherein the visual data comprises a video.

6. The method of claim 5, wherein the video illustrates one or more actions and the player changes comprise replicating the one or more actions illustrated by the video in the electronic casino game.

7. The method of claim 1, wherein the gameplay data defines a betting strategy for a player in the electronic casino game.

8. A system comprising:
a processor; and
a memory coupled with and readable by the processor and storing therein a set of instructions which, when executed by the processor, causes the processor to:
maintain a plurality of trained models related to an electronic casino game, wherein the plurality of trained models represent actions and visual elements in the electronic casino game;
receive a first prompt defining player changes to the actions in the electronic casino game;
generate gameplay data using a generative Artificial Intelligence (AI), the plurality of models, and the received first prompt, wherein the generated gameplay data defines changes to the actions and the visual elements of the electronic casino game; and
provide the generated gameplay data to a gaming system executing the electronic casino game.

9. The system of claim 8, wherein the plurality of models comprises a tuned model pertaining to video visual elements of the electronic casino game based on a transformer for casino games.

10. The system of claim 9, wherein the plurality of models further comprises a Conditional Variational Autoencoder trained on sample casino game visual element embedding for given prompts.

11. The system of claim 8, wherein the instructions further cause the processor to:
receive a second prompt defining a player request for information related to dynamics of the electronic casino game;
generate explanatory information related to the dynamics of the electronic casino game using the generative AI, the plurality of models, and the received second prompt; and
provide the generated explanatory information related to the dynamics of the electronic casino game to a player of the electronic casino game.

12. The system of claim 8, wherein the instructions further cause the processor to:
receive player feedback regarding changes to the actions and the visual elements of the electronic casino game based on the provided gameplay data; and
train the plurality of models based on the received player feedback.

13. The system of claim 8, wherein the instructions further cause the processor to:
maintain a log of player behavior related to the electronic casino game for a player account;
receive a request for the log of player behavior related to the electronic casino game for the player account; and
provide the log of player behavior related to the electronic casino game to a player associated with the player account.

14. The system of claim 8, wherein the instructions further cause the processor to:
record the received first prompt; and
in response to a request to generate a second prompt, providing the recorded first prompt; and
in response to a selection of the first prompt, using the first prompt as the second prompt.

15. A system comprising:
a communications network;
a first gaming system coupled with the communications network, the first gaming system comprising a processor and a memory coupled with and readable by the processor of the first gaming system and storing therein a set of instructions which, when executed by the processor of the first gaming system, causes the processor of the first gaming system to execute an electronic casino game; and
a game customization system coupled with the communications network, the game customization system comprising a processor and a memory coupled with and readable by the processor of the game customization system and storing therein a set of instructions which, when executed by the processor of the game customization system, cause the processor of the game customization system to:
maintain a plurality of trained models related to the electronic casino game, wherein the plurality of trained models represent actions and visual elements in the electronic casino game;
receive a first prompt defining player changes to the actions in the electronic casino game defined by a first player of the electronic casino game;
generate gameplay data using a generative Artificial Intelligence (AI), the plurality of models, and the received first prompt, wherein the generated gameplay data defines changes to the actions and the visual elements of the electronic casino game; and
provide the generated gameplay data to the first gaming system, wherein the instructions stored in the memory of the first gaming system further cause the processor of the first gaming system to apply the gameplay data to the electronic casino game.

16. The system of claim 15, wherein the gameplay data defines a betting strategy in the electronic casino game for the first player.

17. The system of claim 16, wherein the instructions stored in the memory of the first gaming system further cause the processor of the first gaming system to execute the electronic casino game automatically according to the betting strategy for the first player.

18. The system of claim 16, further comprising a second gaming system coupled with the communications network, the second gaming system comprising a processor and a memory coupled with and readable by the processor of the second gaming system and storing therein a set of instructions which, when executed by the processor of the second gaming system, causes the processor of the second gaming system to execute the electronic casino game and wherein the instructions stored in the memory of the game customization system cause the processor of the game customization system to provide the generated gameplay data to the first gaming system.

19. The system of claim 18, wherein the instructions stored in the memory of the second gaming system cause the processor of the second gaming system to apply the gameplay data to the electronic casino game when the electronic casino game is played on the second gaming system by the first player.

20. The system of claim 18, wherein the instructions stored in the memory of the second gaming system cause the processor of the second gaming system to apply the gameplay data to the electronic casino game when the electronic casino game is played on the second gaming system by a second player.
